(19) United States
(12) Patent Application Publication
(10) Pub. No.: US 2024/0017727 A1
(43) Pub. Date: Jan. 18, 2024

(54) SYSTEM AND METHOD FOR TRACTION CONTROL IN A WORK VEHICLE WITH AN ELECTRIC INFINITELY VARIABLE TRANSMISSION USING WHEEL SPEED

(71) Applicant: Deere & Company, Moline, IL (US)

(72) Inventor: Briton T. Eastman, Coffeyville, KS (US)

(21) Appl. No.: 18/357,910

(22) Filed: Jul. 24, 2023

Related U.S. Application Data
(63) Continuation-in-part of application No. 17/585,726, filed on Jan. 27, 2022.

(51) Int. Cl. B60W 30/18; B60W 20/10; B60W 10/06; B60W 10/08

(52) U.S. Cl. CPC B60W 30/18172; B60W 20/10; B60W 10/06; B60W 10/08; B60W 2520/28; B60W 2710/081; B60W 2710/083; B60W 2300/17

(57) ABSTRACT

A work vehicle includes an engine and a transmission assembly having a variator, a gear arrangement, and an electric machine operably connected to provide rotational power to the variator. The transmission assembly selectively transfers power from one or both of the engine and the electric machine to an output shaft to drive ground engaging elements of the work vehicle. A traction control unit controls a speed or torque output of the electric machine to provide traction control, with the traction control unit operating to receive inputs on a predicted ground engaging element speed and an actual ground engaging element speed, compare the predicted ground engaging element speed to the actual ground engaging element speed and, when the predicted ground engaging element speed is less than the actual ground engaging element speed by a threshold amount, reduce the speed or torque output of the electric machine, thereby providing traction control.

### CROSS-REFERENCE TO RELATED APPLICATION(S)

This application is a continuation-in-part of U.S. patent application Ser. No. 17/585,726, filed Jan. 27, 2022, and hereby incorporated by reference.

### STATEMENT OF FEDERALLY SPONSORED RESEARCH OR DEVELOPMENT

Not applicable.

### FIELD OF THE DISCLOSURE

This disclosure generally relates to providing traction control for a work vehicle and, more particularly, providing traction control via operation of an electric variable transmission arrangement in a work vehicle.

### BACKGROUND OF THE DISCLOSURE

It may be useful, in a variety of work vehicles, to utilize both a traditional engine (e.g., an internal combustion engine) and at least one electric machine (motor/generator) to provide useful power to an output member. For example, a portion of engine power may be diverted to drive an electric machine, and the combined power may be delivered to the output member (e.g., a vehicle axle or other output shaft) in a parallel path configuration, or direct power from only the engine or only the electric machine may be delivered to the output member in a series configuration. The engine, the electric machine and the output member may be operatively connected via a variable transmission variable transmission.

### SUMMARY OF THE DISCLOSURE

In one implementation, a work vehicle includes an engine and a transmission assembly having a variator selectively connected to the engine. A gear arrangement is configured to provide a selective gear reduction for transmission of output power from the variator to an output shaft. An electric machine is operably connected to the engine and to the variator, with the electric machine providing rotational power to the variator. The transmission assembly is configured to selectively transfer power from one or both of the engine and the electric machine to the output shaft to drive ground engaging elements of the work vehicle. The work vehicle also includes a traction control unit, including a processor, that controls a speed or torque output of the electric machine to provide traction control for the work vehicle. The traction control unit operates to: receive a first input associated with a predicted ground engaging element speed of at least one of the ground engaging elements of the work vehicle; receive a second input associated with an actual ground engaging element speed of the at least one of the ground engaging elements of the work vehicle; compare the predicted ground engaging element speed to the actual ground engaging element speed; and when the predicted ground engaging element speed is less than the actual predicted ground engaging element speed by more than a threshold amount, reduce the speed or torque output of the electric machine, for driving the output shaft and thereby providing traction control for the ground engaging elements.

In one example of the work vehicle, the transmission assembly is: operable in a parallel path mode where power from the engine and the electric machine is summed by the variator; or operable in a series mode where power from the electric machine is transmitted through the variator to the output shaft and direct mechanical power from the engine is prevented from transferring to the output shaft.

In a further example of the work vehicle, the traction control unit is configured to reduce the speed or torque output of the electric machine, for providing rotational power to the variator, when the predicted ground engaging element speed is less than the actual ground engaging element speed by more than the threshold amount.

In a further example of the work vehicle, the traction control unit operates to identify a slip condition between the ground engaging elements of the work vehicle and ground when the predicted ground engaging element speed is less than the actual ground engaging element speed by more than the threshold amount, and wherein reducing the speed or torque output of the electric machine addresses the slip condition.

In a further example, the work vehicle further includes a work vehicle movement monitoring system configured to monitor the actual ground engaging element speed of the at least one of the ground engaging elements of the work vehicle, the work vehicle movement monitoring system providing the second input to the traction control unit.

In a further example of the work vehicle, the work vehicle movement monitoring system comprises a ground engaging element speed sensor.

In a further example of the work vehicle, the first input associated with the predicted ground engaging element speed is a speed input or a torque input.

In a further example of the work vehicle, after temporarily reducing the speed or torque output of the electric machine, the traction control unit operates to: continue monitoring the predicted ground engaging element speed and the actual ground engaging element speed of the work vehicle; compare the predicted ground engaging element speed to the actual ground engaging element speed; and when a difference between the predicted ground engaging element speed and the actual ground engaging element speed falls within the threshold amount, increase the torque output of the electric machine, for driving the output shaft.

In a further example of the work vehicle, the electric machine includes a first electric machine, and wherein the transmission assembly further includes a second electric machine coupled to the engine via an engine-driven shaft to receive power therefrom, the second electric machine configured to generate an output electrical power responsive to being driven by the engine-driven shaft and provide the output electrical power to the first electric machine.

In another implementation, a method provides traction control in a work vehicle, including an engine and a transmission assembly having an electric machine operably connected to the engine, for selectively transferring power through a variator of the transmission assembly to an output shaft that drives ground engaging elements of the work vehicle. The method includes transferring rotational power from the electric machine to the variator, transmitting a first input to a traction control unit of the work vehicle, the first input comprising a predicted ground engaging element speed of at least one of the ground engaging elements of the work vehicle; transmitting a second input to the traction control unit of the transmission assembly, the second input comprising an actual ground engaging element speed of the work vehicle; comparing, via the traction control unit, the predicted ground engaging element speed and the actual ground engaging element speed; and when the predicted ground engaging element speed is less than the actual ground engaging element speed by more than a threshold amount, controlling the electric machine, via the traction control unit, to reduce a speed or torque output thereof provided to the variator and on to the output shaft, thereby providing traction control for the ground engaging elements.

In an example of the method, transmitting the first input to the traction control unit includes transmitting an operator input of the predicted ground engaging element speed via an operator interface of the work vehicle; and transmitting the second input to the traction control unit includes providing the actual ground engaging element speed from a work vehicle movement monitoring system.

In a further example of the method, providing the actual ground engaging element speed from the work vehicle movement monitoring system comprises providing the actual ground engaging element speed from a ground engaging element speed sensor on the work vehicle.

In a further example, the method includes: identifying, via the traction control unit, a slip condition between the ground engaging elements of the work vehicle and ground when the predicted ground engaging element speed is less than the actual ground engaging element speed by more than the threshold amount; and controlling the electric machine, via the traction control unit, to reduce the speed or torque output thereof, and thereby reduce or eliminate the slip condition.

In a further example, the method includes causing the traction control unit to: continuing to provide the first input and the second input to the traction control unit subsequent to reducing the speed or torque output of the electric machine; compare the predicted ground engaging element speed to the actual ground engaging element speed; and when a difference between the predicted ground engaging element speed and the actual ground engaging element speed falls within the threshold amount, controlling the electric machine, via the traction control unit, to increase the torque output of the electric machine, for driving the output shaft.

In yet another implementation, a work vehicle includes an engine and a transmission assembly having a variator selectively connected to the engine. A gear arrangement is configured to provide a selective gear reduction for transmission of output power from the variator to a differential on an output shaft with first and second shaft portions. An electric machine is operably connected to the engine and to the variator, with the electric machine providing rotational power to the variator. The transmission assembly is configured to selectively transfer power from one or both of the engine and the electric machine to the wherein the transmission assembly is configured to selectively transfer power from one or both of the engine and the electric machine to the differential on the output shaft to drive a first ground engaging element of the work vehicle on the first shaft portion of the output shaft and a second ground engaging element on the second shaft portion of the output shaft. The work vehicle also includes a traction control unit, including a processor, in communication with the electric machine, the traction control operating to identify a slip condition between at least one of the first and second ground engaging elements of the work vehicle and ground, and to reduce a speed or torque output of the electric machine upon identification of the slip condition.

In a further example of the work vehicle, the traction control unit operates to: receive a first input associated with a predicted ground engaging element speed for the first and second ground engaging elements of the work vehicle; receive a second input associated with a first actual ground engaging element speed for the first ground engaging element of the work vehicle; receive a third input associated with a second actual ground engaging element speed for the second ground engaging element; compare the predicted ground engaging element speed to the first actual ground engaging element speed and the second actual ground engaging element speed; and identify the slip condition between the ground engaging elements of the work vehicle and the ground when the predicted ground engaging element speed is less than the first actual ground engaging element speed by more than a first threshold amount and exceeds the second actual ground engaging element by more than a second threshold amount.

In a further example, the work vehicle further includes a work vehicle movement monitoring system configured to monitor the first actual ground engaging element speed of the work vehicle and the second actual ground engaging element speed of the work vehicle, the work vehicle movement monitoring system transmits the second input and the third input to the traction control unit.

In a further example of the work vehicle, the traction control unit operates to temporarily reduce the speed or torque output of the electric machine until a difference between the predicted ground engaging element speed and the first actual ground engaging element speed fall within the first threshold amount and a difference between the predicted ground engaging element speed and the second actual ground engaging element speed fall within the second threshold amount.

In a further example of the work vehicle, the electric machine includes a first electric machine, and the transmission assembly further includes a second electric machine coupled to the engine via an engine-driven shaft to receive power therefrom, the second electric machine configured to generate an output electrical power responsive to being driven by the engine-driven shaft and provide the output electrical power to the first electric machine.

In a further example of the work vehicle, the transmission assembly is: operable in a parallel path mode where power from the engine and the electric machine is summed by the variator; or operable in a series mode where power from the electric machine is transmitted through the variator to the output shaft and direct mechanical power from the engine is prevented from transferring to the output shaft.

The details of one or more embodiments are set forth in the accompanying drawings and the description below. Other features and advantages will become apparent from the description, the drawings and the claims.

### BRIEF DESCRIPTION OF THE DRAWINGS

At least one example of the present disclosure will hereinafter be described in conjunction with the following figures:

FIG. 1 illustrates an example work vehicle incorporating a transmission assembly that provides traction control to inhibit wheel slippage, in accordance with an embodiment;

FIG. 2 is a schematic diagram of an example transmission assembly included in the work vehicle of FIG. 1, as well as a traction control unit, in accordance with an embodiment;

FIG. 3 is a flowchart of one example control scheme for providing traction control in a work vehicle; and

FIG. 4 is a flowchart of a further example control scheme for providing traction control in a work vehicle.

Like reference symbols in the various drawings indicate like elements. For simplicity and clarity of illustration, descriptions and details of well-known features and techniques may be omitted to avoid unnecessarily obscuring the example and non-limiting embodiments of the invention described in the subsequent Detailed Description. It should further be understood that features or elements appearing in the accompanying figures are not necessarily drawn to scale unless otherwise stated.

### DETAILED DESCRIPTION

Embodiments of the present disclosure are shown in the accompanying figures of the drawings described briefly above. Various modifications to the example embodiments may be contemplated by one of skill in the art without departing from the scope of the present invention, as set-forth the appended claims.

### OVERVIEW

As previously noted, various types of work vehicles, such as backhoe loaders and tractors as examples, may include a powertrain having an electric infinitely variable transmission (“eIVT”) that transfers power from an engine and one or more electric machines to an output member or shaft, such as a vehicle axle that drives rotation of ground engaging elements (e.g., wheels, tracks, etc.) of the work vehicle. In the use of such work vehicles, it is understood that traction control systems inhibit or limit the work vehicle's ground engaging elements from slipping during acceleration along different surfaces—i.e., “wheel slip.” Traction of a work vehicle is established as its ground engaging elements contact a surface so that when the ground engaging elements are rotated, usually by a driving force, the work vehicle will be moved along the surface in a desired direction. The combination of the coefficient of friction and the force exerted by ground engaging elements against the surface produces traction. When the coefficient of friction of the surface is less than the force exerted, the ground engaging elements will slip during acceleration of the work vehicle, adversely affecting acceleration performance and driving stability, and causing wear to the ground engaging elements. Once the condition is recognized, a power (speed and torque) applied to the ground engaging elements can be reduced to thereby address the slip condition.

In existing work vehicles, traction control systems may determine slip conditions and work to limit the power transmitted to the ground engaging elements by selectively operating one or more brakes (e.g., wheel brakes) or clutches in the transmission assembly. The traction control system may send a pressure command to a brake or clutch that causes the brake or clutch to engage. This reduces the power to the ground engaging elements either by selectively applying braking or by disengaging the output shaft.

While existing work vehicle traction control systems serve to reduce or eliminate slip, it is recognized that there are downsides to such systems. Primarily, it is recognized that the brake or clutch components operated to control power output to the ground engaging elements will experience wear after repeated usage, which may impact the performance of the traction control system. The brakes and clutches therefore may need to be replaced, perhaps multiple times, during the lifetime of the work vehicle, thereby leading to increased operating costs for the work vehicle.

To enable improved traction control performance and longevity, a traction control unit is provided for a work vehicle having an electric infinitely variable transmission (eIVT), with the eIVT including an electric machine that, alone or in combination with an engine, selectively transfers power to the output shaft to drive ground engaging elements of the work vehicle. To provide traction control for the work vehicle, the traction control unit identifies a slip condition between the ground engaging elements of the work vehicle and ground and, upon identification of such a slip condition, reduces a speed or torque output of the electric machine.

In an embodiment, the traction control unit receives a first input associated with a commanded (or a predicted) ground speed of the work vehicle, receives a second input associated with an actual ground speed of the work vehicle, and compares the commanded ground speed to the actual ground speed. The first input associated with the commanded ground speed is in the form of a speed input or a torque input. When the commanded ground speed exceeds the actual ground speed by more than a threshold amount, the traction control unit reduces the speed or torque output of the electric machine for driving the output shaft, thereby providing traction control for the ground engaging elements.

In an embodiment, the actual ground speed of the work vehicle is determined by a work vehicle movement monitoring system configured to monitor the actual ground speed of the work vehicle. The work vehicle movement monitoring system may be in the form of a global positioning system (GPS) or a ground radar system, as examples.

In a further embodiment, the traction control unit receives a first input associated with a predicted ground engaging element speed of the work vehicle, receives a second input associated with an actual ground engaging element speed of the work vehicle, and compares the predicted ground engaging element speed to the actual ground engaging element speed. The first input associated with the predicted ground engaging element speed is in the form of a speed input or a torque input (e.g., based on user command, an engine output speed, a transmission speed, or a ground speed as determined from GPS, radar, or the like). When the predicted ground engaging element speed is less than the actual ground engaging element speed by more than a threshold amount, the traction control unit reduces the speed or torque output of the electric machine for driving the output shaft, thereby providing traction control for the ground engaging elements.

In some embodiments, a pair of ground engaging elements (e.g., left and right wheels or tracks) may be considered with respect to each other and/or with respect to the predicted ground engaging element speed. For example, each ground engaging element may have an expected or predicted speed based on inputs to a differential that distributes power to each ground engaging element. Typically, accommodating for differences in steering angles or states, the power to each ground engaging element is equal such that the speed should be equal (with accommodation for steering angles and states). During a slip condition, one ground engaging element may increase in speed while the other ground engaging element correspondingly decreases in speed. As a result, the traction control unit may declare a slip condition and decrease power when the actual ground engaging element speed of a first ground engaging element exceeds the predicted ground engaging element speed by a first threshold amount and when the actual ground engaging element speed of a second ground engaging element falls below the predicted ground engaging element speeds by a second threshold amount. The first and second threshold amount are typically the same value, although in some examples, the threshold amounts may be different.

In an embodiment, the actual wheel speed of the work vehicle is determined by a work vehicle movement monitoring system configured to monitor the actual wheel speed of the work vehicle. The work vehicle movement monitoring system may be in the form of a wheel speed sensor, as an example.

The traction control unit may be used to provide traction control to the ground engaging elements of the work vehicle across multiple operational modes of the elVT. That is, the traction control unit may be used to provide traction control to the ground engaging elements with the transmission assembly operating in a parallel path mode where power from the engine and the electric machine is summed by the variator or in a series mode where power from the electric machine is transmitted through the variator to the output shaft and direct mechanical power from the engine is prevented from transferring to the output shaft.

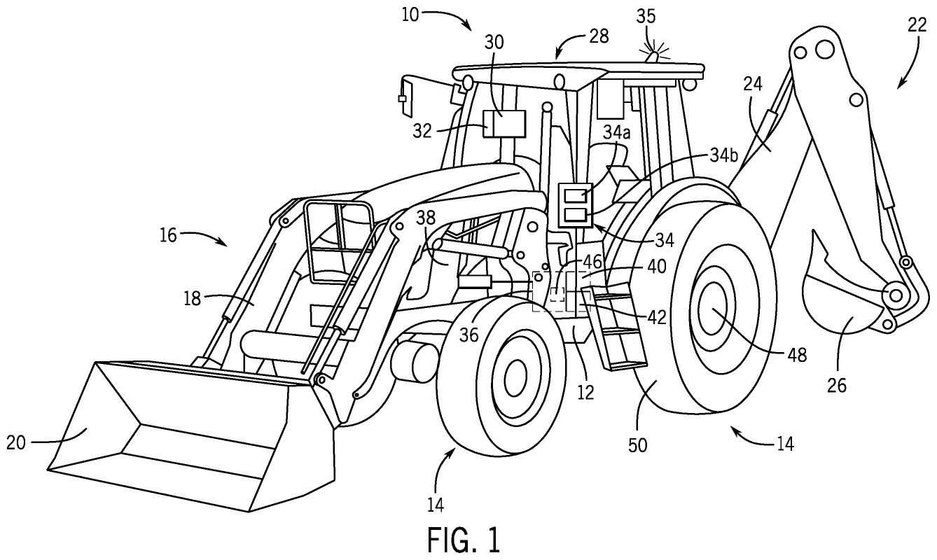

Example embodiments of a work vehicle having a transmission assembly and associated traction control unit that implement a traction control scheme in the vehicle are provided in FIGS. 1-4 according to this disclosure. The following examples notwithstanding, other types of work vehicles and other configurations of electric infinitely variable transmissions would also benefit from the traction control scheme of the invention being incorporated therein. It is therefore recognized that aspects of the invention are not meant to be limited only to the specific embodiments described hereafter.

### EMBODIMENTS OF A SYSTEM FOR MULTI-LAYER BRAKING AND RETARDATION IN A WORK VEHICLE

Referring initially to FIG. 1, a work vehicle is shown that can implement details of one or more embodiments of the disclosure. In the illustrated example, the work vehicle is depicted as a backhoe loader, and thus is hereafter referenced as “backhoe loader 10.” It will be understood, however, that other configurations may be possible, including configurations with the work vehicle as a mining machine, tractor, a harvester, a log skidder, or one of various other work vehicle types.

The backhoe loader 10 includes a chassis 12 and ground engaging elements 14. The ground engaging elements 14 are capable of supporting the chassis 12 and propelling the chassis 12 across the ground. Although the illustrated backhoe loader 10 includes wheels 50 as ground engaging elements 14, the backhoe loader 10 may include other ground engaging mechanisms, such as steel tracks, rubber tracks, or other suitable ground engaging elements. As used herein, any reference or discussion within the context of a “wheel” is also applicable to any ground engaging element, including tracks.

The backhoe loader 10 further includes a loader assembly 16 and a backhoe assembly 22. As illustrated in FIG. 1, the loader assembly 16 includes a loader boom 18 and a work tool 20 in the form of a bucket. The work tool 20 may be capable of moving, excavating, plowing, or performing other material handling functions on a load, such as dirt or other materials. Other suitable work tools include, for example, blades, pallet forks, bale lifts, augers, harvesters, tillers, mowers, and grapples. The loader boom 18 is configured to move relative to the chassis 12 to move and operate the work tool 20. The backhoe assembly 22 of the backhoe loader 10 includes a backhoe boom 24 and a tool such as a backhoe bucket 26 having telehandler tool features. The backhoe boom 24 is attached to the chassis 12 by a swing frame, with the backhoe boom 24 being pivotable relative to the chassis 12. The backhoe bucket 26 is in turn pivotably mounted to the backhoe boom 24 and extendable away therefrom via an extendable dipperstick, such that the backhoe bucket 26 has further freedom of movement during operation.

An operator or autonomous control may operate the backhoe loader 10, including the ground engaging elements 14, the loader assembly 16, and the backhoe assembly 22, from an operator station 28 in the backhoe loader 10. While not shown in FIG. 1, it is recognized that the operator station 28 may include a human-vehicle interface 30 and various controls therein configured to receive input commands from the operator to control, for example, various electric or hydraulic systems associated with actuating and controlling the loader assembly 16 and the backhoe assembly 22. The human-vehicle interface 30 may be configured in a variety of ways and may include input devices 32 that may include one or more joysticks, various switches or levers, one or more buttons, a touchscreen interface that may be overlaid on a display, a keyboard, a speaker, a microphone associated with a speech recognition system, or various other human-machine interface devices.

The backhoe loader 10 includes a controller 34 (or multiple controllers) to control various aspects of the operation of the backhoe loader 10. Generally, the controller 34 (or others) may be configured as a computing device with associated processor devices 34a and memory architectures 34b, as a hard-wired computing circuit (or circuits), as a programmable circuit, or otherwise. As such, the controller 34 may be configured to execute various computational and control functionality with respect to the backhoe loader 10. In some embodiments, the controller 34 may be configured to receive input signals in various formats (e.g., as voltage signals, current signals, and so on), and to output command signals in various formats (e.g., voltage signals, current signals, and so on). In one embodiment, the controller 34 may be configured to receive input commands and to interface with the operator via the human-vehicle interface 30.

The controller 34 may be in communication with various other systems or devices of the backhoe loader 10. For example, the controller 34 may be in communication with various actuators, sensors, and other devices within (or outside of) the backhoe loader 10, including various devices described below. The controller 34 may communicate with other systems or devices (including other controllers) in various known ways, including via a CAN bus (not shown) of the backhoe loader 10, via wireless communication means, or otherwise.

As described in greater detail below, the controller 34 may operate, in part, as a traction control unit that facilitates the collection of various types of vehicle operating parameter data associated with the backhoe loader 10 as part of implementing a traction control scheme in the backhoe loader 10, with such inputs including a commanded work vehicle speed and an actual work vehicle speed. In the illustrated embodiment, inputs provided to the controller 34 as part of its operation as a traction control unit include a commanded vehicle speed input to the controller 34, for example, via the human-vehicle interface 30 and an actual work vehicle speed input to the controller 34 via a work vehicle movement monitoring system 35. Inputs and data received by the controller 34 are utilized to provide traction control in the backhoe loader 10 via operation and control of a transmission 36 included in the backhoe loader 10, on which further details will be provided below. The controller 34 may receive inputs associated with the commanded vehicle speed in terms of any suitable power parameter, namely, the controller 34 may receive speed inputs or torque inputs as representing the commanded or otherwise predicted ground speed, which additionally corresponds to an associated, predicted wheel speed (e.g., a predicted ground engaging element speed). In some examples and/or in some contexts, the predicted wheel speed may be based on the actual speed of the overall backhoe loader 10, e.g., based on GPS or radar.

As indicated, a work vehicle movement monitoring system 35 is provided on the backhoe loader 10 that monitors the actual ground and/or wheel speed of the backhoe loader 10 during operation. The work vehicle movement monitoring system 35 may be in the form of a GPS or a ground radar system, as non-limiting examples, that pinpoints the location of the backhoe loader 10 and monitors movement thereof to derive an actual ground speed of the backhoe loader 10 during operation. In some examples, the work vehicle movement monitoring system 35 may further include one or more wheel speed sensors 48 (or ground engaging element sensors) that monitor the speed of one or more of the wheels 50 (or other ground engaging elements) of the backhoe loader 10 during operation. Although one example of a wheel speed sensor 48 paired with a wheel 50 is discussed below, each wheel 50 may be associated with a respective wheel speed sensor 48, including both rear wheels 50 and/or one or both of the front wheels such that the work vehicle monitoring system 35 may monitor the speed of any of the wheels 50, and as a result, a traction control unit 86 (discussed below) may be implemented to address slippage on any of the wheels 50.

The wheel speed sensor 48 may be positioned in any appropriate location on the backhoe loader 10 in order to measure or derive the actual wheel speed. For example, the wheel speed sensor 48 may be positioned on the rear (and/or front) axle of the wheel loader 10 or on the wheel 50. Generally, the wheel speed sensor 48 may be positioned downstream of the transmission 36. Any suitable type of wheel speed sensor 48 may be provided, including rotary sensors, magnetic pickup sensors, hall effect sensors, and the like. Additional information regarding wheel speed and use of the wheel speed sensor 50 is provided below.

The backhoe loader 10 includes a source of propulsion that, in an example embodiment, is provided as a hybrid electric drive system that includes an engine 38 and a plurality of electric machines 40, 42. The engine 38 and the electric machines 40, 42 may supply power to the transmission 36.

In one example, the engine 38 is an internal combustion engine, such as a diesel engine, that is controlled by the controller 34 to enable start-up of the engine 38, enable shutdown of the engine 38, disable operation of the engine 38, and/or to modify some aspect of operation of the engine 38 or associated system, for example, based on input received from the human-vehicle interface 30. The backhoe loader 10 may include an engine speed sensor 46 configured to determine the speed of the engine 38 during operation.

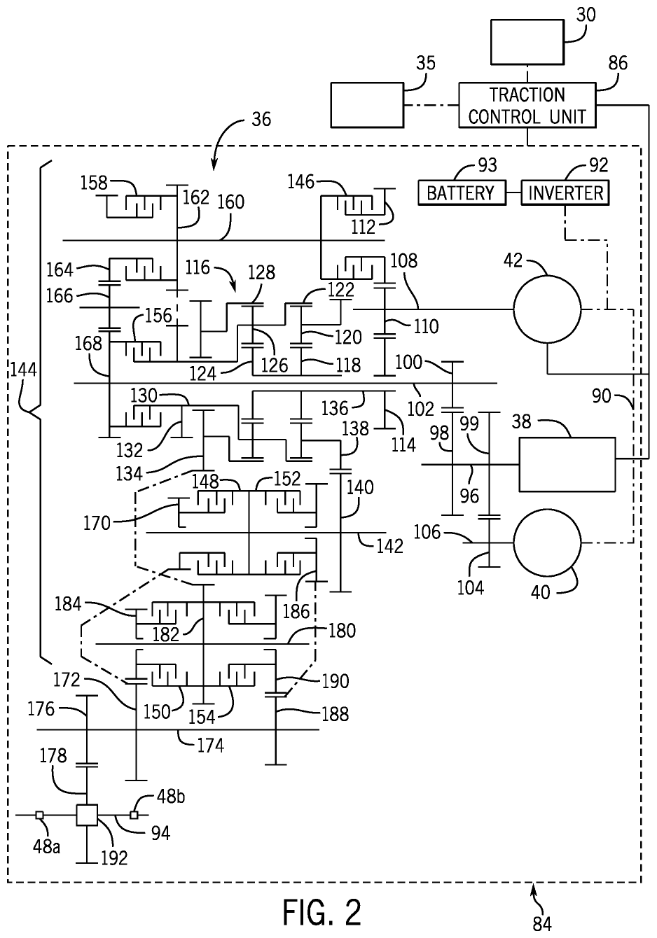

In one example, the electric machines 40, 42 are AC motors, such as permanent magnet AC motors or induction motors. In one implementation, and as will be explained in greater detail in FIG. 2, a first electric machine 40 may receive mechanical power from the engine 38 and convert this power to electrical power, with electrical power from the first electric machine 40 then being provided to the second electric machine 42. This electrical power may then be re-converted by the second electric machine 42 for mechanical output. The electric machines 40, 42 may be controlled by the controller 34 to control a speed, torque, and/or operational mode thereof, with the first electric machine 40 operable in a “regenerative mode” to convert mechanical energy into electric energy and the second electric machine 42 operable in a “motoring mode” to convert electrical energy into mechanical energy.

The transmission 36 transfers power from the engine 38 and second electric machine 42 to a suitable driveline (not shown) coupled to the ground engaging elements 14 of the backhoe loader 10, which may include front and rear wheels, to enable the backhoe loader 10 to move. As described in greater detail below when referring to FIG. 2, the transmission 36 is configured as an elVT that operates in various modes. These modes may include one or more engine-only modes, one or more series electric (e.g., electric-only) modes in which the second electric machine provides final power delivery (without direct mechanical power from the engine 38), and one or more split- or dual-path modes in which outputs from both the engine 38 and the second electric machine 42 are summed and provide a final power delivery (e.g., to a vehicle axle), on which further details will be provided below.

Referring to FIG. 2, an example elVT 84 included in the backhoe loader 10 is illustrated that provides a more detailed discussion of the structure and arrangement of the engine 38, electric machines 40, 42, and transmission 36 of the backhoe loader 10 and how the transmission 36 may be operated to provide traction control as part of a traction control scheme implemented by a traction control unit 86. As indicated previously, the traction control unit 86 may be incorporated as a unit or module in the controller 34, according to some embodiments. It is recognized that the elVT 84 illustrated in FIG. 2 and described here below is merely an example and that transmissions having different arrangements or constructions could instead incorporate details of this disclosure.

In the illustrated embodiment, the elVT 84 includes the transmission 36, the first electric machine 40, and the second electric machine 42. The first electric machine 40 and second electric machine 42 may be connected by an electrical conduit 90. A power inverter 92 may be included and may be operably connected to the first electric machine 40 and/or the second electric machine 42. In some embodiments, the power inverter 92 may feed energy to and/or receive energy from a battery or battery assembly 93. Also, the power inverter 92 may feed energy to and/or receive energy from the elVT 84. Moreover, in some embodiments, the power inverter 92 may off-board power to an implement and/or another energy off-boarding device (not shown).

The transmission 36 transfers power from the engine 38 and the second electric machine 42 to an output shaft 94. As described below, the transmission 36 includes a number of gearing, clutch, and control assemblies to suitably drive the output shaft 94 at different speeds and in multiple directions. Generally, in one example, the transmission 36 of elVT 84 may be any type of electric infinitely variable transmission arrangement, with it recognized that alternatives to the elVT 84 illustrated in FIG. 2 are encompassed in the present invention.

The engine 38 may provide rotational power via an engine output element, such as a flywheel, to an engine shaft 96 according to commands from the traction control unit 86 based on the desired operation. The engine shaft 96 may be configured to provide rotational power to a gear 98 and a gear 99. The gear 98 may be enmeshed with a gear 100, which may be supported on (e.g., fixed to) a shaft 102. The shaft 102 may be substantially parallel to and spaced apart from the engine shaft 96. The shaft 102 may support various components of the eIVT 84, as will be discussed in detail.

The gear 99 may be enmeshed with a gear 104, which is supported on (e.g., fixed to) a shaft 106. The shaft 106 may be substantially parallel to and spaced apart from the engine shaft 96, and the shaft 106 may be connected to the first electric machine 40. Accordingly, mechanical power from the engine (i.e., engine power) may transfer via the engine shaft 96, to the enmeshed gears 99, 104, to the shaft 106, and to the first electric machine 40. The first electric machine 40 may convert this power to electrical power for transmission over the electrical conduit 90 to the second electric machine 42. This converted and transmitted power may then be re-converted by the second electric machine 42 for mechanical output along a shaft 108. Various known control devices (not shown) may be provided to regulate such conversion, transmission, re-conversion, and so on. Also, in some embodiments, the shaft 108 may support a gear 110 (or other similar component). The gear 110 may be enmeshed with and may transfer power to a gear 112. The gear 110 may also be enmeshed with and may transfer power to a gear 114. Accordingly, power from the second electric machine 42 may be divided between the gear 112 and the gear 114 for transmission to other components as will be discussed in more detail below.

The elVT 84 may further include a variator 116 that represents one example of an arrangement that enables an infinitely variable power transmission between the engine 38 and second electric machine 42 and the output shaft 94. In some embodiments, the variator 116 may include at least two planetary gearsets. In some embodiments, the planetary gearset may be interconnected and supported on a common shaft, such as the shaft 102, and the planetary gearsets may be substantially concentric. In other embodiments, the different planetary gearsets may be supported on separate, respective shafts that are nonconcentric. The arrangement of the planetary gearsets may be configured according to the available space within the backhoe loader 10 for packaging the elVT 84.

As shown in the embodiment of FIG. 2, the variator 116 may include a first planetary gearset (i.e., a “low” planetary gearset) with a first sun gear 118, first planet gears and associated carrier 120, and a first ring gear 122. Moreover, the variator 116 may include a second planetary gearset (i.e., a “high” planetary gearset) with a second sun gear 124, second planet gears and associated carrier 126, and a second ring gear 128. The second planet gears and carrier 126 may be directly attached to the first ring gear 122. Also, the second planet gears and carrier 126 may be directly attached to a shaft 130 having a gear 132 fixed thereon. Moreover, the second ring gear 128 may be directly attached to a gear 134. As shown, the shaft 130, the gear 132, and the gear 134 may each receive and may be substantially concentric to the shaft 102. Although not specifically shown, it will be appreciated that the elVT 84 may include various bearings for supporting these components concentrically. Specifically, the shaft 130 may be rotationally attached via a bearing to the shaft 102, and the gear 134 may be rotationally attached via another bearing on the shaft 130.

On the opposite side of the variator 116 (from left to right in FIG. 2), the gear 114 may be mounted (e.g., fixed) on a shaft 136, which also supports the first and second sun gears 118, 124. In some embodiments, the shaft 136 may be hollow and may receive the shaft 102. A bearing (not shown) may rotationally support the shaft 136 on the shaft 102 substantially concentrically.

Furthermore, the first planet gears and associated carrier 120 may be attached to a gear 138. The gear 138 may be enmeshed with a gear 140, which is fixed to a shaft 142. The shaft 142 may be substantially parallel to and spaced apart from the shaft 102.

As noted above, the elVT 84 may be configured for delivering power (from the engine 38 and the second electric machine 42) to the output shaft 94 via the transmission 36. The output shaft 94 may be configured to transmit this received power to ground engaging elements 14 of the backhoe loader 10.

As noted above, the elVT 84 may operate in what may be described alternatively as a parallel path, dual path, or split path mode, so that power from the engine 38 and the second electric machine 42 may be summed by the variator 116, with the summed or combined power delivered to the output shaft 94. The eIVT 84 may also have different speed modes in the split path mode, and these different speed modes may provide different angular speed ranges for the output shaft 94. Furthermore, the eIVT 84 may have one or more forward modes for moving the backhoe loader 10 in a forward direction one or more reverse modes for moving the backhoe loader 10 in a reverse direction. According to embodiments, it is also possible for the eIVT 84 to operate in a series electric mode where power from the second electric machine 42 may be transmitted to the output shaft 94 and direct mechanical power from the engine 38 may be prevented from transferring to the output shaft 94. It is also possible for the eIVT 84 to operate in an engine-only mode where direct mechanical power is transmitted to the output shaft 94 without additional power input being provided by the second electric machine 42.

The eIVT 84 may switch between the speed and directional modes or series and split-path modes using a control assembly 144. The control assembly 144 may include one or more selectable transmission components. The selectable transmission components may have first positions (engaged positions), in which the respective device transmits power from an input component to an output component. The selectable transmission components may also have a second position (a disengaged position), in which the device prevents power transmission from the input to the output component. The selectable transmission components of the control assembly 144 may include one or more wet clutches, dry clutches, dog collar clutches, brakes, synchronizers, or other similar devices. The control assembly 144 may also include an actuator for actuating the selectable transmission components between the first and second positions.

As shown in FIG. 2, the control assembly 144 may include a first clutch 146, a second clutch 148, a third clutch 150, a fourth clutch 152, and a fifth clutch 154. Also, the control assembly 144 may include a forward directional clutch 156 and a reverse directional clutch 158. In some embodiments, the first clutch 146 may be mounted and supported on a shaft 160. Also, the first clutch 146, in an engaged position, may engage the gear 112 with the shaft 160 for rotation as a unit. The first clutch 146, in a disengaged position, may allow the gear 112 to rotate relative to the shaft 160. Also, a gear 162 may be fixed to the shaft 160, and the gear 162 may be enmeshed with the gear 132 that is fixed to the shaft 130. The reverse directional clutch 158 may be supported on the shaft 160 (i.e., commonly supported on the shaft 160 with the first clutch 146). The reverse directional clutch 158 may engage and, alternatively, disengage the gear 162 and a gear 164. The gear 164 may be enmeshed with an idler gear 166, and the idler gear 166 may be enmeshed with a gear 168. The forward directional clutch 156 may be supported on gear 168, which is in turn supported on the shaft 102, to selectively engage shaft 130. Thus, the forward directional clutch 156 may be concentric with both the shaft 130 and the shaft 102. The second clutch 148 may be supported on the shaft 142. The second clutch 148 may engage and, alternatively, disengage the shaft 142 and a gear 170. The gear 170 may be enmeshed with a gear 172. The gear 172 may be fixed to and mounted on a countershaft 174. The countershaft 174 may also support a gear 176. The gear 176 may be enmeshed with a gear 178, which is fixed to the output shaft 94.

The third clutch 150 may be supported on a shaft 180. The shaft 180 may be substantially parallel and spaced at a distance from the shaft 142. Also, a gear 182 may be fixed to and supported by the shaft 180. The gear 182 may be enmeshed with the gear 134 as shown. The third clutch 150 may engage and, alternatively, disengage the gear 182 and a gear 184. The gear 184 may be enmeshed with the gear 172. The fourth clutch 152 may be supported on the shaft 142 (in common with the second clutch 148). The fourth clutch 152 may engage and, alternatively, disengage the shaft 142 and a gear 186. The gear 186 may be enmeshed with a gear 188, which is mounted on and fixed to the countershaft 174. Additionally, the fifth clutch 154 may be supported on the shaft 180 (in common with and concentric with the third clutch 150). The fifth clutch 154 may engage and, alternatively, disengage the shaft 180 and a gear 190. The gear 190 may be enmeshed with the gear 188.

As indicated previously, the eIVT 84 is operable in a number of modes based on selective operation of the transmission, including a split-path mode in which power from the engine 38 and the second electric machine 42 are combined. As introduced above, the traction control unit 86 is coupled to the control assembly 144 for controlling one or more actuators and, as a result, controlling movement of the one or more selective transmission components within the transmission 36, including the first clutch 146, the second clutch 148, the third clutch 150, the fourth clutch 152, the fifth clutch 154, the forward directional clutch 156 and the reverse directional clutch 158. Generally, the traction control unit 86 operates the control assembly 144, as well as the engine 38 and second electric machine 42, to implement the desired function, e.g., to achieve the requested torque at the output shaft 94 for overall control of the backhoe loader 10. This includes vehicle accelerations, stops, starts, shifting between gear ratios, shifting between directions, and the like.

In one example, the output shaft 94 may include a differential 192 to distribute power to one or more portions (e.g., stub-shafts or half-shafts) of the output shaft 94. In the depicted example, a first wheel speed sensor 48a is provided on the first portion of output shaft 94 and a second wheel speed sensor 48b is provided on the second portion of output shaft 94. As discussed below, discrepancies in speeds measured by the first and second wheel speed sensors 48a, 48b may reflect a slip condition, particularly upon comparison with a predicted wheel speed.

According to embodiments, the traction control unit 86 is configured to selectively operate the second electric machine 42 to provide traction control to the ground engaging elements 14 of the backhoe loader 10. As described below, the traction control unit 86 controls operation of the second electric machine 42 to selectively reduce a speed or torque output thereof and thereby address wheel slip of the backhoe loader 10.

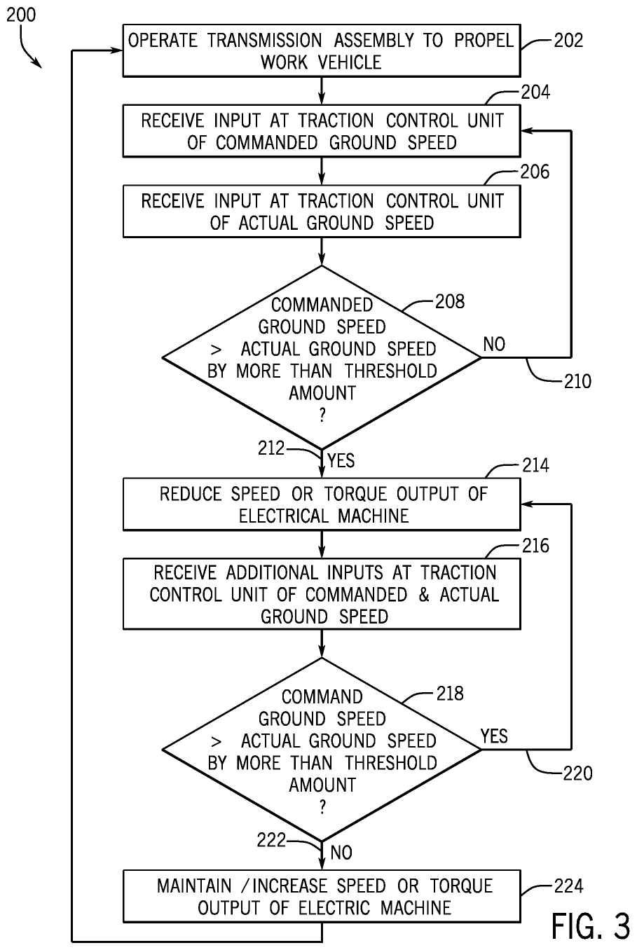

Referring now to FIG. 3, and with continued reference to FIGS. 1 and 2, a flowchart of a method 200 for providing traction control in a work vehicle (e.g., backhoe loader 10) is shown in accordance with the present disclosure, such as may be performed by the traction control unit 86. The traction control unit 86 controls operation of the second electric machine 42 during operation of the elVT 84, such as when an acceleration of the work vehicle is demanded, in order to address wheel slip.

The method 200 begins at step 202 with the elVT 84 operating the engine 38 and second electric machine 42 to provide propulsion of the work vehicle. During such operation, a commanded ground speed is input to the traction control unit 86 at step 204. In one embodiment, the commanded ground speed is input to the traction control unit 86 via a human-vehicle interface 30 (FIG. 1), such as by input devices 32 thereon. The commanded ground speed may be in the form of a speed input or a torque input, which the controller 34 processes using speed or torque parameters depending on whether the control algorithm it is designed with speed or torque control logic.

Along with the commanded ground speed being input to the traction control unit 86, an actual ground speed is also input to the traction control unit 86, as indicated at step 206. According to embodiments, the actual ground speed is input to the traction control unit 86 via a work vehicle movement monitoring system 35 (e.g., GPS or ground radar system) provided on the work vehicle that monitors the actual ground speed of the work vehicle during operation.

The method 200 continues at step 208, where the traction control unit 86 compares the commanded ground speed to the actual ground speed. In particular, the commanded ground speed is compared to the actual ground speed in order to determine whether the commanded ground speed exceeds the actual ground speed by more than a threshold amount, which is indicative of a wheel slip being present in the work vehicle. In one embodiment, the threshold amount above which the difference between the commanded ground speed and actual ground speed is determined to be representative of wheel slip may be a 1% or 2% difference between the commanded ground speed and actual ground speed (i.e., that the commanded ground speed exceeds the actual ground speed by more than 1% or 2%). In other embodiments, the threshold may be larger, such as a 5% difference or more between the commanded ground speed and actual ground speed. Further, the thresholding may also involve resolving a theoretical non-slip ground speed determination at which optimal power (speed or torque) may be provided to the ground engaging wheels without slipping. If so, the comparison at step 208 may further include a comparison of the theoretical non-slip ground speed with either or both of the commanded ground speed and the actual ground speed. The same, different or no thresholding may be applied with respect to the theoretical non-slip ground speed assessment.

If the traction control unit 86 determines that the commanded ground speed does not exceed the actual ground speed by more than the threshold amount, as indicated at 210, then it is determined that no wheel slippage is occurring and the method 200 loops back to steps 204 and 206, with the traction control unit 86 monitoring for and/or receiving additional inputs on the commanded ground speed and the actual ground speed. Alternatively, if the traction control unit 86 determines that the commanded ground speed exceeds the actual ground speed by more than the threshold amount, as indicated at 212, then it is determined that wheel slippage is occurring and the method 200 continues to step 214, where the traction control unit 86 provides commands to the second electric machine 42 that cause the speed or torque output thereof to be reduced. With the second electric machine 42 outputting a reduced speed or torque, the power (speed and torque) provided to the output shaft 94 is thus also reduced, such that the power transferred to the ground engaging elements 14 is reduced. With reduced power being provided to the ground engaging elements 14, the wheel slip condition is addressed.

Subsequent to reducing the speed or torque output of the second electric machine 42 at step 214, the method 200 continues to monitor the commanded ground speed and the actual ground speed of the work vehicle, with additional/continuing inputs on the commanded ground speed and the actual ground speed being provided to the traction control unit 86 at step 216. Upon receiving these inputs, the traction control unit 86 again compares the commanded ground speed to the actual ground speed to determine whether the commanded ground speed exceeds the actual ground speed by more than a threshold amount, as indicated at step 218. As previously indicated, the threshold amount above which the difference between the commanded ground speed and actual ground speed is determined to be representative of wheel slip may be a 1% or 2% difference between the commanded ground speed and actual ground speed, as an example. The thresholding aspect of the comparison at step 218 may also involve resolving a theoretical non-slip ground speed that is compared with either or both of the commanded ground speed and the actual ground speed.

If the traction control unit 86 determines that the commanded ground speed still exceeds the actual ground speed by more than the threshold amount, as indicated at 220, then it is determined that wheel slippage is occurring and the method 200 loops back to step 212, with the traction control unit 86 providing commands to the second electric machine 42 to further reduce speed or torque output. Alternatively, if the traction control unit 86 determines that the commanded ground speed does not exceed the actual ground speed by more than the threshold amount (i.e., it has fallen below the threshold responsive to the speed or torque reduction performed at step 212), as indicated at 222, then it is determined that wheel slippage is no longer occurring and the method 200 continues to step 224. At step 224, the traction control unit 86 may provide commands to the second electric machine 42 that maintain the speed or torque output thereof at its current level or, potentially, cause the speed or torque output of the second electric machine 42 to be increased, if commanded by the operator or if determined that speed or torque can be increased without resulting in wheel slip. Thus, it is recognized that operation of the second electric machine 42 at a reduced speed or torque output may be a temporary operational state that may be exited upon it being determined that wheel slip is no longer present. Another iteration of the method 200 may then be performed as part of an ongoing traction control scheme for the work vehicle.

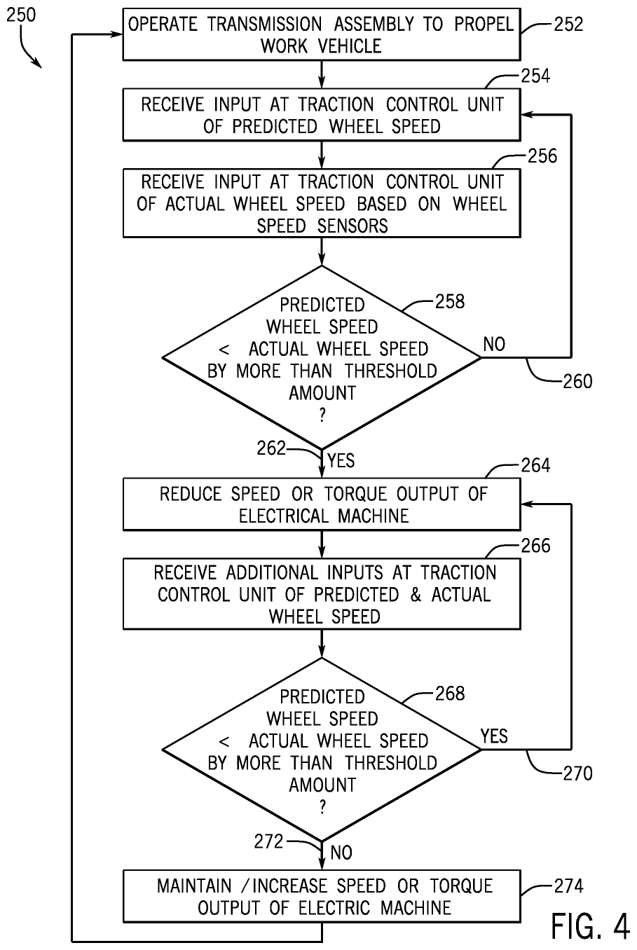

Referring now to FIG. 4, and with continued reference to FIGS. 1 and 2, a flowchart of a further method 250 for providing traction control in a work vehicle (e.g., backhoe loader 10) is shown in accordance with the present disclosure, such as may be performed by the traction control unit 86. As noted, the traction control unit 86 controls operation of the second electric machine 42 during operation of the eIVT 84, such as when an acceleration of the work vehicle is demanded, in order to address wheel slip.

The method 250 begins at step 252 with the elVT 84 operating the engine 38 and second electric machine 42 to provide propulsion of the work vehicle. During such operation, a predicted wheel speed is input to the traction control unit 86 at step 254. In one embodiment, the predicted wheel speed is input to the traction control unit 86 via a human-vehicle interface 30 (FIG. 1), such as by input devices 32 thereon. The predicted wheel speed may be in the form of a speed input or a torque input, which the controller 34 processes using speed or torque parameters depending on whether the control algorithm is designed with speed or torque control logic. In some examples, the predicted wheel speed may be based on an actual ground speed as determined by GPS or radar. In other words, a speed of the overall loader 10 may suggest an expected, theoretical, or otherwise predicted speed of each wheel. The loader speed may be expressed or otherwise converted into a predicted wheel speed and vice versa, e.g., based on the transmission, articulation of a steering arrangement, a wheel size, and/or other parameter that may impact the resulting wheel speed referenced in the discussion below.

Along with the predicted wheel speed being input to the traction control unit 86, an actual wheel speed is also input to the traction control unit 86, as indicated at step 256. According to embodiments, one or more actual wheel speeds are input to the traction control unit 86 via a work vehicle movement monitoring system 35 (e.g., based on one or more wheel speed sensors 48) provided on the work vehicle that monitors the actual wheel speeds of the work vehicle during operation.

The method 250 continues at step 258, where the traction control unit 86 compares the predicted wheel speed to one or more of the actual wheel speeds. In particular, the predicted wheel speed is compared to one or more actual wheel speeds in order to determine whether the predicted wheel speed is less than the actual wheel speed by more than a threshold amount (or, in other words, the actual wheel speed exceeds the predicted wheel speed by the threshold amount), which is indicative of a wheel slip being present in the work vehicle. In one embodiment, the threshold amount determined to be representative of wheel slip may be a 1% or 2% difference between the predicted wheel speed and the actual wheel speed (i.e., that the predicted wheel speed is below the actual wheel speed by more than 1% or 2%). In other embodiments, the threshold may be larger, such as a 5% difference or more. Further, the threshold may also involve resolving a theoretical non-slip ground speed determination at which optimal power (speed or torque) may be provided to the wheels without slipping. If so, the comparison at step 258 may further include a comparison of the theoretical non-slip wheel speed with either or both of the predicted wheel speed and the actual wheel speed. The same, different or no thresholding may be applied with respect to the theoretical non-slip wheel speed assessment.

If the traction control unit 86 determines that the predicted wheel speed does not fall below the actual wheel speed by more than the threshold amount, as indicated at 260, then it is determined that no wheel slippage is occurring and the method 250 loops back to steps 254 and 256, with the traction control unit 86 monitoring for and/or receiving additional inputs on the predicted wheel speed and the actual wheel speed. Alternatively, if the traction control unit 86 determines that the predicted wheel speed is less than the actual wheel speed by more than the threshold amount, as indicated at 262, then it is determined that wheel slippage is occurring and the method 250 continues to step 254, where the traction control unit 86 provides commands to the second electric machine 42 that cause the speed or torque output thereof to be reduced. With the second electric machine 42 outputting a reduced speed or torque, the power (speed and torque) provided to the output shaft 94 is thus also reduced, such that the power transferred to the ground engaging elements 14 is reduced. With reduced power being provided to the ground engaging elements 14, the wheel slip condition is addressed.

Subsequent to reducing the speed or torque output of the second electric machine 42 at step 264, the method 250 continues to monitor the predicted wheel speed and the actual wheel speed of the work vehicle, with additional/continuing inputs on the predicted wheel speed and the actual wheel speed being provided to the traction control unit 86 at step 256. Upon receiving these inputs, the traction control unit 86 again compares the predicted wheel speed to the actual wheel speed to determine whether the predicted wheel speed falls below the actual wheel speed by more than a threshold amount, as indicated at step 268. As previously indicated, the threshold amount determined to be representative of wheel slip may be a 1% or 2% difference between the predicted wheel speed and actual wheel speed, as an example. The thresholding aspect of the comparison at step 268 may also involve resolving a theoretical non-slip wheel speed that is compared with either or both of the predicted wheel speed and the actual wheel speed.

If the traction control unit 86 determines that the predicted wheel speed is still below the actual wheel speed by more than the threshold amount, as indicated at 270, then it is determined that wheel slippage is occurring and the method 250 loops back to step 262, with the traction control unit 86 providing commands to the second electric machine 42 to further reduce speed or torque output. Alternatively, if the traction control unit 86 determines that the predicted wheel speed is not less than the actual wheel speed by more than the threshold amount (i.e., it has fallen within the threshold responsive to the speed or torque reduction performed at step 262), as indicated at 272, then it is determined that wheel slippage is no longer occurring and the method 250 continues to step 274. At step 274, the traction control unit 86 may provide commands to the second electric machine 42 that maintains the speed or torque output thereof at its current level or, potentially, cause the speed or torque output of the second electric machine 42 to be increased, if commanded by the operator or if determined that speed or torque can be increased without resulting in wheel slip. Thus, it is recognized that operation of the second electric machine 42 at a reduced speed or torque output may be a temporary operational state that may be exited upon it being determined that wheel slip is no longer present. Another iteration of the method 250 may then be performed as part of an ongoing traction control scheme for the work vehicle.

In some examples, steps 256, 258, 264, 266, and 268 may be considered with respect to more than one wheel (or other ground engaging element) 50 of the loader 10. As noted above, the output shaft 94 may include a differential 192 to distribute power to one or more portions (e.g., stub-shafts or half-shafts) of the output shaft 94, each monitored by a respective wheel speed sensor 48a, 48b. In step 256, inputs from each of the wheel speed sensors 48a, 48b may be provided; and in step 258, actual wheel speeds for each wheel (e.g., left and right wheels) may be considered relative to each other and/or relative to the predicted wheel speed. Due to the nature of power distribution at the differential 192, when one wheel is slipping and operating at a higher speed than predicted, the other wheel may be operating at a lower speed than predicted. As such, the traction control unit 86 may declare a slip condition when 1) the predicted wheel speed is less than a first actual wheel speed (e.g., of a first wheel) by more than a first threshold amount and 2) the predicted wheel speed is greater than a second actual wheel speed (e.g., of a second wheel) by more than a second threshold amount. The first and second threshold amount are typically the same value, although in some examples, the threshold amounts may be different. Upon determining a slip condition, the method 250 proceeds to steps 264, 266, and 268 in a similar manner; and in step 268, the traction control unit 86 performs a similar comparison to again evaluate the slip condition.

Accordingly, the traction control unit 86 provides a closed-loop control scheme by which wheel slip in the work vehicle can be addressed. By selectively controlling operation of the second electric machine 42 to reduce the speed or torque output thereof upon identification of a wheel slip condition, the traction control unit 86 provides an accurate and fast response to address the wheel slip condition. This addressing of a slip condition without actuating clutches in the elVT 84 reduces mechanical wear in the transmission assembly, so as to prolong the life thereof. In some examples, identification of the slip condition based on wheel speed may provide better results than ground speed due to the higher resolution of the wheel speed sensors as compared to GPS or radar, although other conditions or consideration may favor ground speed as compared to wheel speed.

### CONCLUSION

The foregoing has thus provided a traction control unit for a work vehicle that includes an elVT therein. The traction control unit selectively controls an electric machine of the eIVT that, alone or in combination with an engine, selectively transfer power to an output shaft to drive ground engaging elements of the work vehicle. To provide traction control for the work vehicle, the traction control unit identifies a slip condition between the ground engaging elements of the work vehicle and ground and, upon identification of such a slip condition, reduces a speed or torque output of the electric machine. Identification of the slip condition may be performed via a comparison between a commanded ground or wheel speed of the work vehicle and an actual ground or wheel speed of the work vehicle, with a slip condition identified when the commanded ground speed exceeds the actual ground speed by more than a threshold amount or when the commanded wheel speed is less than the actual wheel speed by more than a threshold amount.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C). Also, the use of “one or more of” or “at least one of” in the claims for certain elements does not imply other elements are singular nor has any other effect on the other claim elements. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

Finally, as used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A work vehicle comprising:
an engine;
a transmission assembly comprising:
a variator selectively connected to the engine;
a gear arrangement configured to provide a selective gear reduction for transmission of output power from the variator to an output shaft; and
an electric machine operably connected to the engine and to the variator, with the electric machine providing rotational power to the variator;
wherein the transmission assembly is configured to selectively transfer power from one or both of the engine and the electric machine to the output shaft to drive ground engaging elements of the work vehicle; and
a traction control unit, including a processor, that controls a speed or torque output of the electric machine to provide traction control for the work vehicle, the traction control unit operating to:
receive a first input associated with a predicted ground engaging element speed of at least one of the ground engaging elements of the work vehicle;
receive a second input associated with an actual ground engaging element speed of the at least one of the ground engaging elements of the work vehicle;
compare the predicted ground engaging element speed to the actual ground engaging element speed; and
when the predicted ground engaging element speed is less than the actual predicted ground engaging element speed by more than a threshold amount, reduce the speed or torque output of the electric machine, for driving the output shaft and thereby providing traction control for the ground engaging elements.

2. The work vehicle of claim 1, wherein the transmission assembly is:
operable in a parallel path mode where power from the engine and the electric machine is summed by the variator; or
operable in a series mode where power from the electric machine is transmitted through the variator to the output shaft and direct mechanical power from the engine is prevented from transferring to the output shaft.

3. The work vehicle of claim 1, wherein the traction control unit is configured to reduce the speed or torque output of the electric machine, for providing rotational power to the variator, when the predicted ground engaging element speed is less than the actual ground engaging element speed by more than the threshold amount.

4. The work vehicle of claim 1, wherein the traction control unit operates to identify a slip condition between the ground engaging elements of the work vehicle and ground when the predicted ground engaging element speed is less than the actual ground engaging element speed by more than the threshold amount, and wherein reducing the speed or torque output of the electric machine addresses the slip condition.

5. The work vehicle of claim 1, further comprising a work vehicle movement monitoring system configured to monitor the actual ground engaging element speed of the at least one of the ground engaging elements of the work vehicle, the work vehicle movement monitoring system providing the second input to the traction control unit.

6. The work vehicle of claim 5, wherein the work vehicle movement monitoring system comprises a ground engaging element speed sensor.

7. The work vehicle of claim 1, wherein the first input associated with the predicted ground engaging element speed is a speed input or a torque input.

8. The work vehicle of claim 1, wherein after temporarily reducing the speed or torque output of the electric machine, the traction control unit operates to:
continue monitoring the predicted ground engaging element speed and the actual ground engaging element speed of the work vehicle;
compare the predicted ground engaging element speed to the actual ground engaging element speed; and
when a difference between the predicted ground engaging element speed and the actual ground engaging element speed falls within the threshold amount, increase the torque output of the electric machine, for driving the output shaft.

9. The work vehicle of claim 1, wherein the electric machine comprises a first electric machine, and wherein the transmission assembly further comprises a second electric machine coupled to the engine via an engine-driven shaft to receive power therefrom, the second electric machine configured to generate an output electrical power responsive to being driven by the engine-driven shaft and provide the output electrical power to the first electric machine.

10. A method for providing traction control in a work vehicle including an engine and a transmission assembly having an electric machine operably connected to the engine, for selectively transferring power through a variator of the transmission assembly to an output shaft that drives ground engaging elements of the work vehicle, the method comprising:
transferring rotational power from the electric machine to the variator;
transmitting a first input to a traction control unit of the work vehicle, the first input comprising a predicted ground engaging element speed of at least one of the ground engaging elements of the work vehicle;
transmitting a second input to the traction control unit of the transmission assembly, the second input comprising an actual ground engaging element speed of the work vehicle;
comparing, via the traction control unit, the predicted ground engaging element speed and the actual ground engaging element speed; and
when the predicted ground engaging element speed is less than the actual ground engaging element speed by more than a threshold amount, controlling the electric machine, via the traction control unit, to reduce a speed or torque output thereof provided to the variator and on to the output shaft, thereby providing traction control for the ground engaging elements.

11. The method of claim 10, wherein transmitting the first input to the traction control unit comprises transmitting an operator input of the predicted ground engaging element speed via an operator interface of the work vehicle; and
wherein transmitting the second input to the traction control unit comprises providing the actual ground engaging element speed from a work vehicle movement monitoring system.

12. The method of claim 11, wherein providing the actual ground engaging element speed from the work vehicle movement monitoring system comprises providing the actual ground engaging element speed from a ground engaging element speed sensor on the work vehicle.

13. The method of claim 10, further comprising:
identifying, via the traction control unit, a slip condition between the ground engaging elements of the work vehicle and ground when the predicted ground engaging element speed is less than the actual ground engaging element speed by more than the threshold amount; and
controlling the electric machine, via the traction control unit, to reduce the speed or torque output thereof, and thereby reduce or eliminate the slip condition.

14. The method of claim 10, further comprising causing the traction control unit to:
continuing to provide the first input and the second input to the traction control unit subsequent to reducing the speed or torque output of the electric machine;
compare the predicted ground engaging element speed to the actual ground engaging element speed; and
when a difference between the predicted ground engaging element speed and the actual ground engaging element speed falls within the threshold amount, controlling the electric machine, via the traction control unit, to increase the torque output of the electric machine, for driving the output shaft.

15. A work vehicle comprising:
an engine;
a transmission assembly comprising:
a variator selectively connected to the engine;
a gear arrangement configured to provide a selective gear reduction for transmission of output power from the variator to a differential on an output shaft with first and second shaft portions; and
an electric machine operably connected to the engine and to the variator, with the electric machine providing rotational power to the variator;
wherein the transmission assembly is configured to selectively transfer power from one or both of the engine and the electric machine to the differential on the output shaft to drive a first ground engaging element of the work vehicle on the first shaft portion of the output shaft and a second ground engaging element on the second shaft portion of the output shaft; and
a traction control unit, including a processor, in communication with the electric machine, the traction control unit operating to:
identify a slip condition between at least one of the first and second ground engaging elements of the work vehicle and ground; and
reduce a speed or torque output of the electric machine upon identification of the slip condition.

16. The work vehicle of claim 15, wherein the traction control unit operates to:
receive a first input associated with a predicted ground engaging element speed for the first and second ground engaging elements of the work vehicle;
receive a second input associated with a first actual ground engaging element speed for the first ground engaging element of the work vehicle;
receive a third input associated with a second actual ground engaging element speed for the second ground engaging element;
compare the predicted ground engaging element speed to the first actual ground engaging element speed and the second actual ground engaging element speed; and
identify the slip condition between the ground engaging elements of the work vehicle and the ground when the predicted ground engaging element speed is less than the first actual ground engaging element speed by more than a first threshold amount and exceeds the second actual ground engaging element by more than a second threshold amount.

17. The work vehicle of claim 16, further comprising a work vehicle movement monitoring system configured to monitor the first actual ground engaging element speed of the work vehicle and the second actual ground engaging element speed of the work vehicle, the work vehicle movement monitoring system transmits the second input and the third input to the traction control unit.

18. The work vehicle of claim 16, wherein the traction control unit operates to temporarily reduce the speed or torque output of the electric machine until a difference between the predicted ground engaging element speed and the first actual ground engaging element speed fall within the first threshold amount and a difference between the predicted ground engaging element speed and the second actual ground engaging element speed fall within the second threshold amount.

19. The work vehicle of claim 15, wherein the electric machine comprises a first electric machine, and wherein the transmission assembly further comprises a second electric machine coupled to the engine via an engine-driven shaft to receive power therefrom, the second electric machine configured to generate an output electrical power responsive to being driven by the engine-driven shaft and provide the output electrical power to the first electric machine.

20. The work vehicle of claim 15, wherein the transmission assembly is:
operable in a parallel path mode where power from the engine and the electric machine is summed by the variator; or
operable in a series mode where power from the electric machine is transmitted through the variator to the output shaft and direct mechanical power from the engine is prevented from transferring to the output shaft.
